(19) United States
(12) Patent Application Publication
(10) Pub. No.: US 2025/0053143 A1
(43) Pub. Date: Feb. 13, 2025

(54) Determining Controllable Process Parameters for a Battery Production System

(71) Applicant: Siemens Aktiengesellschaft, München (DE)

(72) Inventors: Axel Reitinger, München (DE); Manfred Baldauf, Erlangen (DE); Sascha Schulte, Höchstadt (DE); Jonas Witt, Nürnberg (DE); Cecilia Margareta Bruhn, München (DE); Barbara Schricker, Erlangen (DE); Clemens Otte, München (DE)

(73) Assignee: Siemens Aktiengesellschaft, München (DE)

(21) Appl. No.: 18/711,208

(22) PCT Filed: Oct. 28, 2022
(86) PCT No.: PCT/EP2022/080262

§ 371 Date: May 17, 2024

(30) Foreign Application Priority Data
Nov. 17, 2021 (EP) 21208658.1

(51) Int. Cl. G05B 13/02; H01M 10/0525

(52) U.S. Cl. CPC G05B 13/0275; H01M 10/0525

(57) ABSTRACT

Various embodiments of the teachings herein include a method for controlling a battery production system. An example includes: measuring production parameters with a plurality of sensors; determining a quality value of a battery cell with the measurement values; calculating a dependency of the quality value on the measurement values with a computing unit; calculating a dependency of the quality value on changed production parameters by performing a machine learning method; determining a controllable process parameter with an improved quality value using a parameter optimization for the machine learning method including a Bayesian optimization, wherein measurement values with associated quality values are included in the optimization as reference points; and using the controllable process parameter with an improved quality value in operation of the battery production system.

### CROSS-REFERENCE TO RELATED APPLICATIONS

This application is a U.S. National Stage Application of International Application No. PCT/EP2022/080262 filed Oct. 28, 2022, which designates the United States of America, and claims priority to EP Application Serial No. 21208658.1 filed Nov. 17, 2021, the contents of which are hereby incorporated by reference in their entirety.

### TECHNICAL FIELD

The present disclosure relates to battery production. Various embodiments of the teachings herein include methods and/or systems for determining controllable process parameters for a battery production system.

### BACKGROUND

Lithium-ion accumulators, also referred to below as lithium-ion batteries, are employed in mobile and stationary applications as energy stores due to their high power density and energy density. A lithium-ion battery typically comprises multiple battery cells. A battery cell, in particular a lithium-ion battery cell, comprises a plurality of layers. These layers typically comprise anodes, cathodes, separators and further elements. These layers can be configured as stacks or as windings.

The production of these lithium-ion batteries comprises a plurality of manufacturing steps. In each individual one of these process steps there is a plurality of controllable process parameters. Furthermore, during the production of the lithium-ion batteries there are a large number of variables influencing the quality of the battery cells produced. In particular, disruptions or deviations from the norm can occur during the production process. In the prior art process parameters are predefined by laboratory tests and are checked and adapted by means of pilot line tests during operation of the battery production system.

Both the laboratory tests and the checking during operation are disadvantageously time-consuming and are not possible for all influencing variables. Due to the complex plurality of variables influencing the quality of the battery storage unit produced, the rejection rates during battery production are high. This has a negative effect on the capacity of the battery production system.

### SUMMARY

The teachings of the present disclosure include systems and methods for battery production which reduce the rejection rates during battery production. For example, some embodiments include a method for determining controllable process parameters (x) for a battery production system (1), including: ascertaining measurement values of production parameters (A, B) in the battery production system (1) by means of sensors (3), ascertaining at least one quality value of at least one battery cell produced in the battery production system (1) with the ascertained measurement values, wherein the quality value is associated with the measurement values, transferring the at least one quality value and the measurement values to a computing unit (2), ascertaining the dependency of the at least one quality value on the measurement values in the computing unit (2), ascertaining a dependency of the at least one quality value on changed production parameters which differ in value from the measurement values, in the computing unit, wherein a machine learning method is performed in the computing unit (2), and ascertaining at least one controllable process parameter from the changed production parameters with an improved quality value, wherein the ascertaining takes place on the basis of a parameter optimization for the machine learning method, wherein a Bayesian optimization for the ascertained dependency is used as parameter optimization, wherein measurement values with associated quality values are included in the optimization as reference points (12, 13, 14).

In some embodiments, the Bayesian optimization uses the machine learning method in an iterative process, and suggestions for production parameters are successively generated and are tested in the model generated by the machine learning method.

In some embodiments, process parameters, stochastic production parameters, and disturbance variables are used as production parameters.

In some embodiments, material properties, temperatures, air humidity, dust concentration, airflow, delivery information and/or batch information are used as production parameters.

In some embodiments, entrapments of foreign particles, temperature deviations, air humidity deviations, vibrations, a raw solution inhomogeneity are measured as disturbance variables.

In some embodiments, the temperature, agitation speeds of a raw solution for an electrode layer, properties of the raw solution, feed speeds and/or a mass flow of the raw solution during the coating processes for the electrode layer, a contact pressure and/or a gap dimension of a coating system for production of the electrode layer and/or a concentration of the components of a raw solution for an electrode layer are used as process parameters.

In some embodiments, a self-discharge rate, an internal resistance, a capacity, an idle voltage, a deformation value, an internal resistance, a weight of the battery cell, a layer thickness, a surface quality, a surface loading, a porosity and/or a residual moisture of the electrode layer is used as the quality value.

In some embodiments, the quality value is determined by measuring an idle voltage, a deformation of the battery cell, an internal resistance, a cell capacity and/or a weight of the battery cell.

In some embodiments, high-precision coulometry and/or an infrared method is performed to determine the quality value.

In some embodiments, the at least one quality value and the measurement values form a measured data space, which is output graphically.

In some embodiments, the changed production parameters and/or changed process parameters in the measured data space are displayed to a user graphically overlapping.

In some embodiments, the data space is represented as a two-dimensional diagram.

In some embodiments, a changed process parameter ascertained as described herein is set and battery cells are produced with these changed process parameters.

In some embodiments, the method is performed during the production of battery cells with the changed process parameters.

As another example, some embodiments include a battery production system (1) with a computing unit (2) configured to perform one or more of the methods described herein.

### BRIEF DESCRIPTION OF THE DRAWINGS

Further features, properties and advantages of the teachings of the present disclosure emerge from the following description, with reference to the accompanying figures, in which, shown schematically:

FIG. 1 shows a battery production system with sensors and a computing unit incorporating teachings of the present disclosure;

FIG. 2 shows a target function and a model on the basis of a Bayesian optimization;

FIG. 3 shows a parameter space with measured and ascertained controllable process parameter pairs; and

FIG. 4 shows a diagram of an example method for determining controllable process parameters for a battery production system incorporating teachings of the present disclosure.

### DETAILED DESCRIPTION

Some embodiments of the teachings herein include a method for determining controllable process parameters for a battery production system. First, measurement values of production parameters in the battery production system are ascertained by means of sensors. Furthermore, at least one quality value of at least one battery cell produced in the battery production system with the ascertained measurement values is also ascertained. The quality value is in this case associated with the measurement values. The at least one quality value and the measurement values associated therewith are transferred to a computing unit.

Subsequently, the dependency of the at least one quality value on the measurement values is ascertained in the computing unit. Furthermore, the dependency of the at least one quality value on changed production parameters which differ from the measurement values is ascertained. The ascertaining takes place on the basis of a dependency determined by means of a machine learning method. At least one controllable process parameter is ascertained from the changed production parameters with an improved quality value. At least one controllable process parameter is ascertained on the basis of a parameter optimization for the machine learning method. The battery production system is operated with the ascertained changed process parameter and battery cells are produced using these changed process parameters.

An example battery production system comprises a computing unit configured to perform one or more of the methods described herein for determining controllable process parameters for the battery production system.

Using the methods described herein, it is possible to determine complex relationships between production parameters and a quality value and to subsequently identify controllable process parameters. By producing batteries using these process parameters, battery cells can be produced which satisfy a minimum requirement for the quality value. In other words, it is thus possible to set the battery production system automatically. The methods speed up the process of setting the production parameters of a battery production system, in particular r in terms of a design-of-experiment. Thus fewer optimization steps are required to find an optimal setting of the production parameters of the battery production system. This enables the battery production system to be optimized more quickly, so that the rejection rate of the battery production system is reduced.

It is further possible to detect complex cause-and-effect relationships which cannot be detected by a manual evaluation by technical personnel. Furthermore, the optimization results can be employed across multiple production lines of a battery production system.

In some embodiments, the parameter optimization for the machine learning method is carried out using a Bayesian optimization. In the optimization, measurement values with the associated quality values are used as reference points. The Bayesian optimization uses the machine learning method in an iterative process, in order to approximate an optimum production parameter. In particular, successive suggestions for production parameters are generated and are tested in the model generated by the machine learning method. The use of Bayesian optimization advantageously reduces the computing time needed to find optimum production parameters.

In some embodiments, an improved model can in turn be generated on the basis of new production parameters by means of the machine learning method.

In some embodiments, stochastic production parameters and disturbance variables are used as production parameters and process parameters. The parameters that can be set in a controllable manner are referred to as process parameters. These are in particular agitation speeds of a raw solution for an electrode layer, temperatures, properties of the raw solution, in particular a viscosity of the raw solution, feed speeds and/or a mass flow of the raw solution during the coating process for the electrode layer, a contact pressure and/or a gap dimension of the coating system, an amount of electrolytes for the battery cell and/or the electrode layer, concentrations of the components of the raw solution, drying profiles, storage times of the components employed, web tensions of the electrode layer web, and welding temperatures.

Furthermore, stochastic production parameters are also understood as production parameters. Stochastic production parameters are understood in particular to include vibrations, airflows in the production system, a batch change of raw materials, a dust concentration in the battery production system, an airflow in the battery production system, the behavior of technical personnel, solar radiation, and an ambient air pressure.

Furthermore, disturbance variables are also understood as production parameters. Disturbance variables are understood in particular to include deviations of the process parameters from target values, in changes air humidity, vibrations, inhomogeneities in the paste, interruptions, in particular a power outage, short-term voltage variations, batch changes, a dust concentration, blockages in nozzles and/or slots, and mechanical wear on the machines.

Thus, a plurality of production parameters may bedetected. Furthermore, a plurality of production parameters is correlated with a quality value. Furthermore, the production parameters may be used to identify controllable process parameters which can further improve the quality value. Thus it is possible to correlate the complex relationships during battery production with the quality value of the batteries produced, and thus to identify controllable process parameters which improve the quality value.

On the one hand, the method may be used when starting up the battery production system in order to achieve a high quality of the batteries produced in as short a time as possible. The controllable process parameter can be ascertained after a disturbance variable has changed the battery production. In this case a controllable process parameter would be ascertained which is set as a countermeasure for an error in the production chain of battery production.

In some embodiments, a self-discharge rate, an internal resistance, a capacity, an idle voltage, a deformation value, an internal resistance or a weight of the battery cell is used as a quality value. These quality values are ascertained end-of-line, in other words at the end of battery production. A self-discharge rate is understood as the ability of a battery cell to maintain its stored energy when idle without load. Measuring the self-discharge rate thus allows an approximate statement to be made about how well the battery cell works in real operation. Furthermore, the self-discharge rate is a measure of the likelihood that the cell will suffer a short-circuit over the course of its life. Thus it is possible to make a statement about the safety of the battery cell produced.

In some embodiments, the at least one quality value is determined by measuring an idle voltage, a deformation of the battery cell, an internal resistance, a coulombic efficiency, a cell capacity, and a weight of the battery cell. In some embodiments, the quality value may be determined by means of high-precision coulometry, electrochemical impedance spectroscopy. These measurement methods may be suitable for determining quality values and on the basis thereof for determining whether the battery storage unit can store and deliver a required electrical power.

In some embodiments, a layer thickness, a surface quality, a surface loading, a porosity and/or a residual moisture of the electrode layer is used as a quality value. These quality values are ascertained during the production of the battery cell. The at least one quality value is measured during the production of the battery cell in particular by means of dilatometry, an X-ray method and/or an infrared method.

In some embodiments, the at least one quality value and the measurement values form a measured data space, which is output graphically. The changed production parameters and/or changed controllable process parameters are advantageously also represented in the measured data space. In some embodiments, the representation takes place in a two-dimensional diagram. This enables a user to check the suggested controllable process parameters. It is also possible for a user to suggest further controllable process parameters manually.

In some embodiments, the production system is operated with the controllable process parameter. Measurement values are in turn recorded to determine new changed process parameters, in order advantageously to achieve a further optimization of the battery production system.

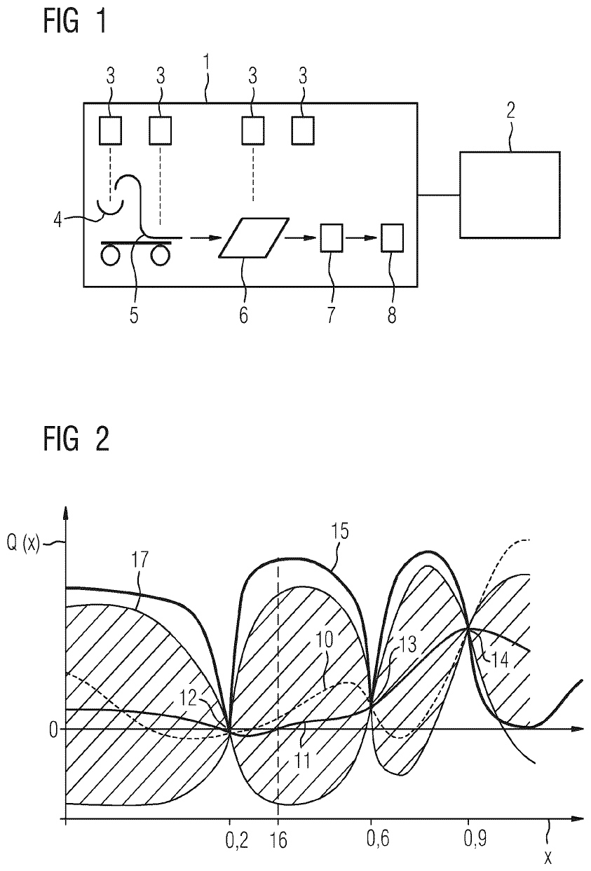

FIG. 1 shows a battery production system 1 incorporating teachings of the present disclosure which is connected to a computing unit 2. The battery production system 1 comprises at least one device with a raw solution 4 for an electrode layer 5. It also comprises a coating system for the production of the electrode layer 5. It likewise comprises a winding unit 6 for winding the electrodes to produce a lithium-based energy storage unit. The battery production system 1 also comprises a forming unit 7 for the initial charging and discharging of the battery cell. It also comprises an end-of-line testing unit 8 for determining quality values of the battery cell. The battery production system 1 also comprises sensors 3.

These sensors 3 measure production parameters, such as in particular properties of the raw solution (e.g. viscosity, temperature), of the electrode layer (layer thickness, rawness) and of the winding system (temperature, winding speed). Furthermore, sensors measure the temperature, the dust content, the airflow, and the air humidity in the space of the battery production system. In particular, optical (imaging) sensors and hyperspectral cameras are also employed as sensors. The production systems and sensors mentioned are not exhaustively mentioned here. In particular, sensors are associated with each production step. The sensors generate data, which is transferred to the computing unit 1 as measurement values.

Furthermore, a quality value of a battery produced in the battery production system is determined. The quality value refers in particular to a self-discharge rate, an internal resistance, a capacity, an idle voltage, a deformation value, an internal resistance or a weight of a battery cell. The quality value can in particular be ascertained by means of a high-precision coulometry method for measuring a capacity. The quality value for an electrode layer can be ascertained by means of an infrared method for determining the residual moisture of the active material coating or by means of a visual inspection.

The at least one quality value and the measurement values are transferred to the computing unit. The dependency of the at least one quality value on the measurement values is ascertained in the computing unit. In other words, this means that the measured quality value and the measurement values are correlated with one another. The dependency of the at least one quality value on changed production parameters which differ in value from the measurement values is ascertained.

This dependency is ascertained in the computing unit 2 by means of a machine learning method with a Bayesian optimization. In this case the measurement values with the associated measured quality values serve as reference points. In other words, not only are relationships between the measured values ascertained, but for unmeasured production parameters it is also ascertained what the quality value there is expected to be. On the basis thereof, at least one controllable process parameter can be ascertained which satisfies a minimum requirement for the quality value. It is advantageously also possible to use the method to suggest how at least one controllable process parameter can be changed in order either to increase the quality value or, in the case of a disturbance factor during battery production, continuously to ensure the quality of the battery storage units produced.

FIG. 2 shows by way of example how the Bayesian optimization is used, on the basis of a first reference point 12, a second reference point 13 and a third reference point 14, to ascertain a production parameter x and the dependency, in this example of a quality value, on the production parameter x Q (x). A model that estimates the unknown target function 10 is trained on the known data points (12, 13, 14) using a machine learning method. The target function here represents the dependency of the quality value on the production parameters. The model can in particular be a neural network, a Gaussian process, a support vector machine, or a random forest. Existing domain knowledge can in particular be included in the form of so-called Physics-Informed Neural Networks (PINNs). The uncertainty that the model has due to the restricted amount of data is likewise estimated.

The model including the estimated uncertainty is used to suggest a parameter value 16, on which the unknown target function is evaluated. The evaluation can in particular be carried out as an experiment on the real battery production system 1 or by means of a simulation. The quality value for the new parameter value 16 ascertained hereby is added to the dataset and the model is trained or updated afresh on the expanded amount of data. This is continued successively until the optimum of the unknown target function is found sufficiently accurately. The overall target is thus to achieve the unknown optimum with as few iterations and as accurately as possible.

Parameter pairs that make possible a high quality value of the battery storage units for the battery production system 1 are ascertained on the basis of the relationship between the quality value of production parameters for unmeasured production parameter values.

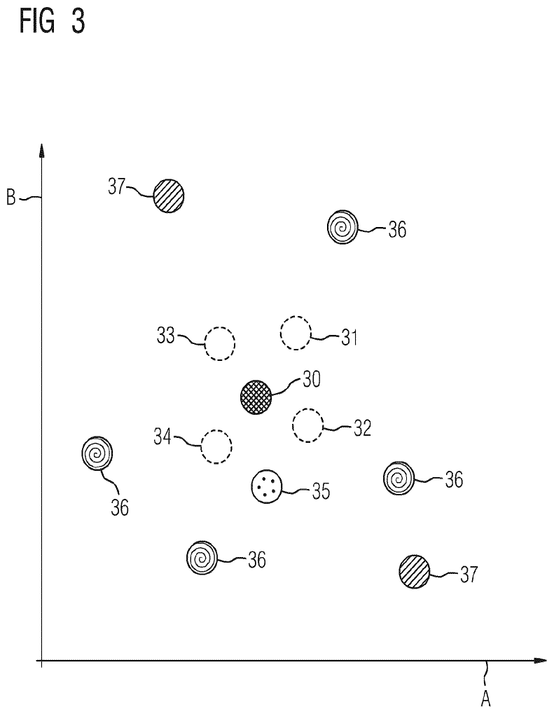

FIG. 3 shows a parameter space of measured and ascertained controllable production parameter pairs. In FIG. 3, the production parameter A is shown on the x-axis and the production parameter B on the y-axis. In this example A refers to the layer thickness of the electrode layer for an anode or cathode, B describes the composition of the raw solution or paste for the electrode layer. As further examples, the viscosity of the raw solution can be plotted as A and the porosity of the electrode layer as B. Furthermore, the contact pressure during the electrode layer production and the porosity of the electrode layer or the drying temperature during the production of the electrode layer and the residual moisture content can in particular also be represented in this diagram. Measured production parameter pairs can be seen which have a first quality class 30, a second quality class 35, a third quality class 36 and a fourth quality class 37. The first quality class in this case has the highest quality, the fourth quality class 37 the lowest.

A first controllable process parameter pair 31, a second controllable process parameter pair 32, a third controllable process parameter pair 33 and a fourth controllable process parameter pair 34 are ascertained on the basis of the machine learning method. It is now possible to set a selected controllable process parameter pair in the battery production system and in turn to measure measurement values and the quality value, to transfer them to the computing unit, in turn to establish dependencies which are evaluated using a machine learning method, in turn to ascertain new production parameters and controllable process parameters based thereon which can be used in a nest step. In other words the method thus makes it possible to realize a design-of-experiment with which an improvement in the quality values of the battery storage units in production and thus also a reduction in the rejection rate of the battery storage units produced is enabled.

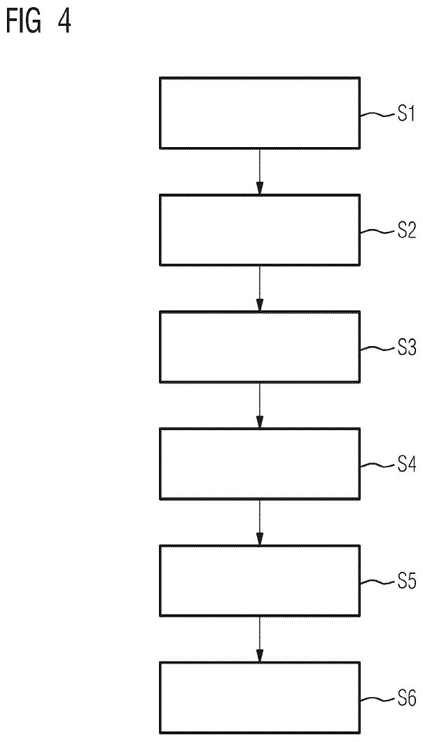

FIG. 4 shows a diagram of an example method for ascertaining controllable process parameters for a battery production system incorporating teachings of the present disclosure. In a first step S1 measurement values of production parameters in the battery production system are ascertained. In a second step S2 at least one quality value of at least one battery cell produced in the battery production system with the determined measurement values is ascertained. The quality value is in this case associated with a measurement value. In a third step S3 the at least one quality value and the measurement values are transferred to a computing unit. In a fourth step S4 the dependency of the at least one quality value on the measurement values is ascertained in the computing unit. In a fifth step S5 the dependency of the at least one quality value on changed production parameters which differ in value from the measurement values is ascertained in the computing unit. In this case a machine learning method with a Bayesian optimization is performed in the computing unit. The optimization is in this case based on reference points, which represent the measurement values with the associated quality values. In a sixth step at least one controllable process parameter is ascertained from the changed production parameters with a changed quality value which satisfies a minimum requirement for the quality value, this being ascertained on the basis of the dependency determined by means of Bayesian optimization.

Although the invention has been illustrated and described in greater detail by the preferred exemplary embodiment, the invention is nevertheless not restricted by the disclosed examples. Variations can be derived therefrom by the person skilled in the art, without departing from the scope of protection of the invention, as is defined by the following claims.

### LIST OF REFERENCE CHARACTERS

1 Battery production system
2 Computing unit
3 Sensor
4 Raw solution
5 Electrode layer
6 Winding unit
7 Forming unit
8 End-of-line testing unit
10 Target function
11 Model
12 First reference point
13 Second reference point
14 Third reference point
15 Probable improvement
16 First optimization point
30 Quality class 1
31 First controllable process parameter pair
32 Second controllable process parameter pair
33 Third controllable process parameter pair
34 Fourth controllable process parameter pair
35 Quality class 2
36 Quality class 3
37 Quality class 4
A Production parameter A
B Production parameter B
X Production parameter x
Q (x) Quality value in dependence on x
S1 Ascertaining measurement values of production parameters in the battery production system
S2 Ascertaining at least one quality value of at least one battery cell produced in the battery production system with the ascertained measurement values, wherein the quality value is associated with the measurement values
S3 Transferring the at least one quality value and the measurement values to a computing unit
S4 Ascertaining a dependency of the at least one quality value on the measurement values in the computing unit
S5 Ascertaining the dependency of the at least one quality value on changed production parameters which differ in value from the measurement values, in the computing unit, wherein a machine learning method with a Bayesian optimization is performed in the computing unit, wherein measurement values with associated quality values are included in the optimization as reference points
S6 Ascertaining at least one controllable process parameter from the changed production parameters with a changed quality value which satisfies a minimum requirement for the quality value, wherein the ascertaining takes place on the basis of the dependency determined by means of Bayesian optimization.

What is claimed is:

1. A method for controlling a battery production system the method comprising:
taking measurement values of production parameters in the battery production system with a plurality of sensors;
determining a quality value of a battery cell produced in the battery production system with the measurement values, wherein the quality value is associated with the measurement values;
transferring the quality value and the measurement values to a computing unit;
calculating a dependency of the quality value on the measurement values in the computing unit;
calculating a dependency of the quality value on changed production parameters different in value from the measurement values, in the computing unit by performing a machine learning method;
determining a controllable process parameter from the changed production parameters with an improved quality value using a parameter optimization for the machine learning method including a Bayesian optimization wherein measurement values with associated quality values are included in the optimization as reference points; and
using the controllable process parameter with an improved quality value in operation of the battery production system.

2. The method as claimed in claim 1, wherein the Bayesian optimization includes using the machine learning method in an iterative process, generating successive suggestions for production parameters and testing the suggestions in the model generated by the machine learning method.

3. The method as claimed in claim 1, wherein the production parameters include process parameters, stochastic production parameters, and disturbance variables.

4. The method as claimed in claim 1, wherein the production parameters include material properties, temperatures, air humidity, dust concentration, airflow, delivery information and/or batch information.

5. The method as claimed in claim 1, wherein the disturbance variables include entrapments of foreign particles, temperature deviations, air humidity deviations, vibrations, a raw solution inhomogeneity.

6. The method as claimed in claim 1, wherein the process parameters include temperature, agitation speeds of a raw solution for an electrode layer, properties of the raw solution, feed speeds and/or a mass flow of the raw solution during the coating processes for the electrode layer, a contact pressure and/or a gap dimension of a coating system for production of the electrode layer and/or a concentration of the components of a raw solution for an electrode layer.

7. The method as claimed in claim 1, wherein the quality value includes a self-discharge rate, an internal resistance, a capacity, an idle voltage, a deformation value, an internal resistance, a weight of the battery cell, a layer thickness, a surface quality, a surface loading, a porosity and/or a residual moisture of the electrode layer.

8. The method as claimed in wherein determining the quality value includes measuring an idle voltage, a deformation of the battery cell, an internal resistance, a cell capacity and/or a weight of the battery cell.

9. The method as claimed in claim 1, wherein determining the quality value includes performing high-precision coulometry and/or an infrared method.

10. The method as claimed in claim 1, wherein the at least one quality value and the measurement values form a measured data space turned into graphical output.

11. The method as claimed in claim 1, further comprising displaying the changed production parameters and/or changed process parameters in the measured data space displayed to a user graphically overlapping.

12. The method as claimed in one of claim 10, wherein the data space is represented as a two-dimensional diagram.

13-15. (canceled)
